(19) United States
(12) Patent Application Publication
(10) Pub. No.: US 2019/0102134 A1
(43) Pub. Date: Apr. 4, 2019

(54) DISPLAY SYSTEM, DISPLAY DEVICE, AND DISPLAY METHOD OF DISPLAY SYSTEM

(71) Applicant: Coretronic Corporation, Hsin-Chu (TW)

(72) Inventors: Chueh-Ching Chen, Hsin-Chu (TW); Jui-Chi Chen, Hsin-Chu (TW); Fu-Shan Wang, Hsin-Chu (TW); Hsin-Ya Lai, Hsin-Chu (TW); Ching-Ho Chang, Hsin-Chu (TW); Heng-Cheng Chen, Hsin-Chu (TW)

(73) Assignee: Coretronic Corporation, Hsin-Chu (TW)

(21) Appl. No.: 16/143,485

(22) Filed: Sep. 27, 2018

(30) Foreign Application Priority Data
Sep. 29, 2017 (CN) 201710903193.5

(51) Int. Cl. G06F 3/14; G09G 3/22

(52) U.S. Cl. CPC G06F 3/1446; G09G 2320/066; G09G 2320/0626; G09G 3/22

(57) ABSTRACT

Disclosed are a display system, a display device and a display method of a display system. A main display device corrects display properties of a displayed image of a secondary display device according to display properties of a displayed image of the main display device, so as to adjust the displayed image of the secondary display device to have the same display properties as the displayed image of the main display device, thereby effectively improving the convenience of use of the display system and the display device.

### CROSS-REFERENCE TO RELATED APPLICATION

This application claims the priority benefit of China application serial no. 201710903193.5, filed on Sep. 29, 2017. The entirety of the above-mentioned patent application is hereby incorporated by reference herein and made a part of this specification.

### BACKGROUND

### Technical Field

The disclosure relates to an electronic device, particularly to a display system, a display device and a display method of a display system.

### Description of Related Art

Projectors are capable of projecting an image onto a larger screen to allow more people to watch the content displayed on the screen at the same time, and are therefore often used in public places such as offices, schools and so on. Moreover, as household display products are increasing in size, projectors are gradually gaining in popularity with families and have become a common electronic product in daily life.

Nowadays, at a place such as a control room, an exhibition hall or a stage where a large seamless display is often used, to enable a plurality of projectors to project images consistent in display properties, setting of the projectors is usually performed by an external control device. However, since the external control device needs to be prepared additionally and the projectors have to be set one by one by the external control device, convenience of use is reduced. In addition, generally, the external control device communicates with the projectors via an RJ45 network cable or an RS232 control line. Thus, as the number of projectors increases, the complexity of line connection between devices also increases so that both installation time and cost of the projectors are increased.

The information disclosed in this Background section is only for enhancement of understanding of the background of the described technology and therefore it may contain information that does not foam the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a display system, a display device and a display method of a display system, by which the convenience of use of the display system and the display device can be effectively improved.

To achieve one of, a part of or all of the above objectives or other objectives, one embodiment of the disclosure provides a display system including a main display device and a plurality of secondary display devices. The secondary display devices are coupled to the main display device. The secondary display devices and the main display device respectively display a plurality of displayed images. The secondary display devices respectively transmit display properties information corresponding to the displayed images of the secondary display devices to the main display device. The main display device corrects display properties of the displayed images of the secondary display devices according to display properties of the displayed image of the main display device, so as to adjust the displayed images of the secondary display devices to have the same display properties as the displayed image of the main display device.

The disclosure further provides a display device coupled to a plurality of secondary display devices, wherein the display device and the secondary display devices respectively provide a plurality of displayed images. The display device includes a storage circuit and a processor. The storage circuit stores an algorithm adjusting display properties of the displayed images of the secondary display devices. The processor is coupled to the storage circuit. The processor calculates display properties adjustment parameters of the secondary display devices according to display properties of the displayed image of the display device, display properties information of the displayed images of the secondary display devices that is provided by the secondary display devices and the algorithm stored in the storage circuit. The display device transmits the display properties adjustment parameters of the secondary display devices to the secondary display devices, so as to adjust the displayed images of the secondary display devices to have the same display properties as the displayed image of the display device.

The disclosure further provides a display method of a display system, wherein the display system includes a main display device and a plurality of secondary display devices. The display method of the display system includes the following steps. A plurality of displayed images are provided respectively by the main display device and the secondary display devices. Display properties information of the displayed images of the secondary display devices is received by the main display device. The display properties information of the displayed images of the secondary display devices is corrected by the main display device according to display properties of the displayed image of the main display device, so as to adjust the displayed images of the secondary display devices to have the same display properties as the displayed image of the main display device.

Based on the above, in embodiments of the disclosure, the display properties of the displayed image of the secondary display device are corrected by the main display device according to the display properties of the displayed image of the main display device, so as to adjust the displayed image of the secondary display device to have the same display properties as the displayed image of the main display device. By using the main display device to control the secondary display device to automatically adjust the display properties of the displayed image of the secondary display device in this way, consistency in the display properties between the main display device and the secondary display device can be achieved, thus considerably improving the convenience of use of the display system and the display device.

Other objectives, features and advantages of the invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a display system according to an embodiment of the disclosure.

FIG. 2 is a schematic view of a main display device according to an embodiment of the disclosure.

FIG. 3 is a flowchart of a display method of a display system according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

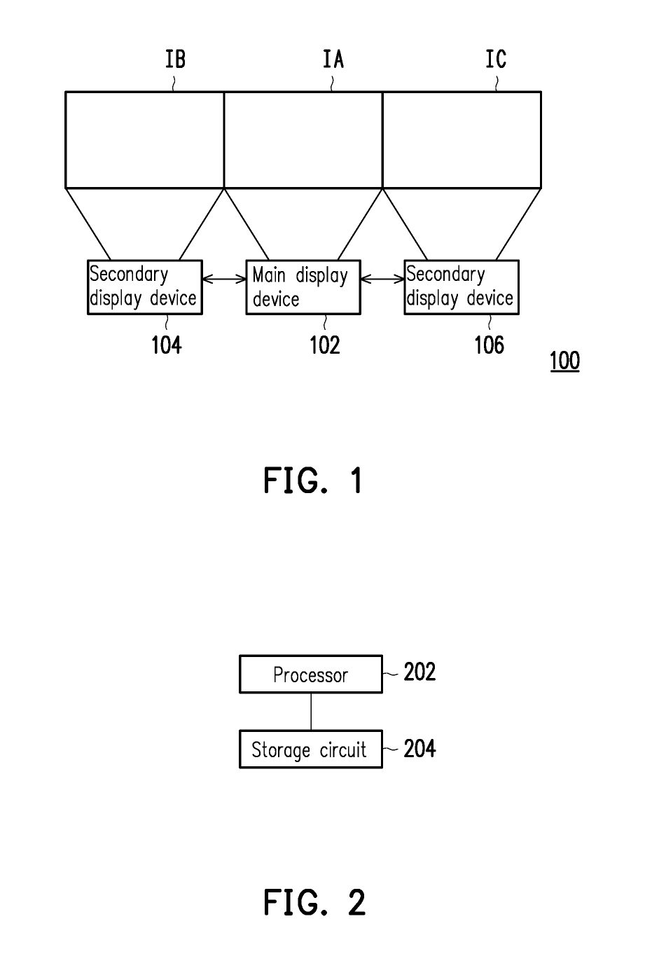

FIG. 1 is a schematic view of a display system according to an embodiment of the disclosure. Referring to FIG. 1, in the embodiment, a display system 100 includes a main display device 102, a secondary display device 104 and a secondary display device 106, wherein the main display device 102 may be coupled to the secondary display devices 104 and 106 in a wired or wireless manner, wherein the wireless communication techniques used include, for example, Bluetooth, ultra-wideband (UWB), wireless fidelity (WiFi), Zigbee, or a wireless local area network (WLAN), and the wired communication techniques used include, for example, a data transmission line such as an electric wire, an electric cable or a metal lead wire. The main display device 102 is coupled to the secondary display devices 104 and 106 in a wireless manner, which effectively reduces complexity of line connection between devices, so as to reduce both installation time and cost of projectors. In the embodiment, the main display device 102, the secondary display device 104 and the secondary display device 106 may be, for example but not limited to, projectors. In other embodiments, the main display device 102, the secondary display device 104 and the secondary display device 106 may be other display devices such as liquid crystal displays.

The main display device 102, the secondary display device 104 and the secondary display device 106 may respectively display the same, different or related screens. For example, in the embodiment of FIG. 1, the main display device 102, the secondary display device 104 and the secondary display device 106 respectively provide displayed images IA, IB and IC. In the embodiment, the displayed images IA, IB and IC are connected to each other side by side. The content of the displayed images IA, IB and IC can be stitched with each other to form a complete seamless display. That is, the displayed images IA, IB and IC may each be responsible for displaying a portion of the content of the seamless display so as to cooperatively generate a large-sized display. In some embodiments, the displayed images IA, IB and IC may be respectively different or the same, and do not work together to provide a seamless display. In addition, the displayed images IA, IB and IC are not limited to being connected to each other side by side.

The main display device 102 may transmit a correction command to the secondary display devices 104 and 106, so as to request the secondary display devices 104 and 106 to respectively transmit display properties information of the displayed images IB and IC provided by the secondary display devices 104 and 106 to the main display device 102, wherein the main display device 102 may actively transmit the correction command to the secondary display devices 104 and 106 when a display function is activated or when the main display device 102 is turned on; alternatively, a user may order the main display device 102 to transmit the correction command to the secondary display devices 104 and 106 through an input interface (which is not illustrated and is, for example, a remote control or a button on the main display device). The display properties information may be, for example, display setting parameters such as image size, contrast, brightness, chromaticity, trapezoidal correction settings and so on, and the display properties information includes at least one of the aforesaid display setting parameters. According to current display properties of the displayed image IA, the main display device 102 may automatically correct screen properties of the displayed images IB and IC of the secondary display devices 104 and 106, so as to adjust the displayed images IB and IC of the secondary display devices 104 and 106 to have the same screen properties as the displayed image IA of the main display device 102. For example, the main display device 102 receives the display properties information (e.g., setting parameters such as image size, contrast, brightness, chromaticity, and trapezoidal correction settings) of the displayed images IB and IC provided from the secondary display devices 104 and 106, and determines whether the display properties information of the displayed images IB and IC of the secondary display devices 104 and 106 is the same as the display properties information of the displayed image IA of the main display device 102; if not the same, the main display device 102 controls the secondary display devices 104 and 106 to perform image display according to the display properties information of the main display device 102, so that the displayed images IB and IC of the secondary display devices 104 and 106 have the same display properties as the displayed image IA of the main display device 102. In other embodiments, if the main display device 102, the secondary display device 104 and the secondary display device 106 are liquid crystal displays, the display properties information may be, for example, display setting parameters corresponding to liquid crystal displays, such as image contrast, brightness, chromaticity and so on.

It is worth noting that, due to difference in degree of aging of components, even if the main display device 102, the secondary display device 104 and the secondary display device 106 perform image display using the same display setting parameters, the displayed images IA, IB and IC may still exhibit different display properties. For example, in the case where the main display device 102, the secondary display device 104 and the secondary display device 106 are all projectors, if the main display device 102, the secondary display device 104 and the secondary display device 106 differ in the degree of aging of light source, even if their respective internal control units (not illustrated) are set to perform projection using the same brightness parameter, the displayed images IA, IB and IC are still unable to provide image content having the same brightness. At this moment, the main display device 102 may control the secondary display devices 104 and 106 to adjust the display properties of the displayed images IB and IC according to the actually exhibited difference in the display properties between the displayed images IA, IB and IC, so that the displayed images IA, IB and IC can have the same display properties.

In some embodiments, at least one of the main display device 102, the secondary display device 104 and the secondary display device 106 detects the display properties (e.g., image size, contrast, brightness, chromaticity, trapezoidal distortion and so on) of the displayed images IA, IB and IC. For example, at least one of the main display device 102, the secondary display device 104 and the secondary display device 106 may include a detector such as a video camera, so as to capture the displayed images IA, IB and IC. The display properties of the displayed images IA, IB and IC are determined according to the captured images. According to a detection result of the detector, the main display device 102 controls the secondary display devices 104 and 106 to adjust the displayed images IB and IC to have the same display properties as the displayed image IA of the main display device 102. For example, according to the brightness of the displayed image IA, the displayed images IB and IC may be adjusted to have the same brightness as the displayed image IA; or, the locations and trapezoidal distortion of the displayed images IB and IC may be corrected, and the image size of the displayed images IB and IC may be adjusted according to the image size of the displayed image IA, so that the displayed images IA, IB and IC may be stitched with each other to obtain a seamless display having the same display properties and no trapezoidal distortion. In some embodiments, the main display device 102 may not only control the secondary display devices 104 and 106 to adjust the display properties of the displayed images IB and IC, but may also adjust the display properties of the displayed image IA, so as to effectively enable the displayed images IA, IB and IC to have the same display properties.

In detail, as shown in FIG. 2, the main display device 102 may include, for example, a processor 202 and a storage circuit 204 coupled to the processor 202, wherein the storage circuit 204 may store an algorithm which is used to adjust the display properties of the displayed images IB and IC of the secondary display devices 104 and 106. The storage circuit 204 stores the algorithm and is able to transmit the algorithm to the processor 202. When the main display device 102 has received the display properties information of the displayed images IB and IC from the secondary display devices 104 and 106, the processor 202 of the main display device 102 calculates display properties adjustment parameters of the secondary display devices 104 and 106 according to the display properties of the displayed image IA of the main display device 102, the display properties information of the displayed images IB and IC provided by the secondary display devices 104 and 106, and the algorithm stored in the storage circuit 204. The main display device 102 may transmit the display properties adjustment parameters of the secondary display devices 104 and 106 to the secondary display devices 104 and 106, so as to enable the secondary display devices 104 and 106 to adjust the displayed images IB and IC to have the same display properties as the displayed image IA of the main display device 102 according to the display properties adjustment parameters. The processor 202 may be, for example, a digital signal processor (DSP), a microcontroller unit (MCU), a central processing unit (CPU), a complex programmable logic device (CPLD) or other circuit capable of performing the same functions or a combination of the aforesaid devices.

The algorithm stored in the storage circuit 204 may be updated by, for example, update algorithm information provided by an external device (e.g., but not limited to, a USB adaptor). In some embodiments, the main display device 102 may connect to another device (e.g., but not limited to, a computer or a cloud server) to obtain the update algorithm information so as to update the algorithm stored in the storage circuit 204. By updating the algorithm stored in the storage circuit 204 in this way, the processor 202 can calculate how to adjust the display properties of the displayed images IB and IC according to the updated algorithm, thus effectively adjusting the displayed images IB and IC to have the same display properties as the displayed image IA or adjusting the displayed images IA, IB and IC into an improved seamless display. In the above, the storage circuit 204 may be, for example, a random access memory (RAM), a flash memory, a read-only memory (ROM), an erasable programmable read-only memory (EPROM), an electrically erasable programmable read-only memory (EEPROM), a register, a hard disk drive, a floppy disk, a compact disc, or any other machine-readable (e.g., computer-readable) storage medium.

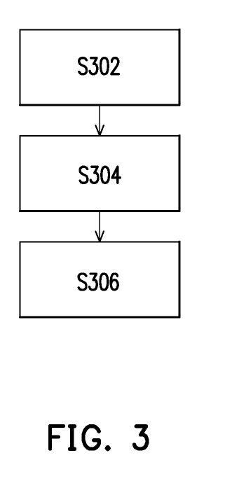

FIG. 3 is a flowchart of a display method of a display system according to an embodiment of the disclosure. Please refer to FIG. 3. It is known from the aforesaid embodiments that a display method of a display system may at least include the following steps. First of all, a main display device and a secondary display device respectively display a plurality of displayed images (step S302), wherein the main display device may be coupled to the secondary display device in a wired or wireless manner. Next, display properties information of the displayed image of the secondary display device is received by the main display device (step S304). For example, a correction command may first be transmitted to the secondary display device from the main display device, so as to request the secondary display device to provide the corresponding display properties information of the displayed image. The display properties of the displayed image of the secondary display device that is adjusted by the main display device includes at least one of image size, brightness, chromaticity, contrast and resolution. In the case where the main display device and the secondary display device are projectors, the display properties of the displayed image may further include, for example, location and trapezoidal distortion of the displayed image.

Then, the received display properties information of the displayed image of the secondary display device is corrected by the main display device according to the display properties of the displayed image of the main display device, so as to adjust the displayed image of the secondary display device to have the same display properties as the displayed image of the main display device (step S306). For example, when the displayed image of the main display device and the displayed image of the secondary display device are used to form a seamless display, the same display properties can be provided at each position on the seamless display. In some embodiments, the main display device may further receive update algorithm information from outside (e.g., receive update algorithm information from a USB adaptor, or obtain update algorithm information from a cloud server through the Internet), so as to update an algorithm for adjusting the display properties of the displayed image of the secondary display device. In the embodiment, when the main display device has received the display properties information of the displayed image from the secondary display device, the main display device calculates display properties adjustment parameters of the secondary display device according to the current display property of the displayed image of the main display device and the display properties information of the displayed image provided by the secondary display device. The main display device transmits the display properties adjustment parameters of the secondary display device to the secondary display device, so as to enable the secondary display device to adjust the displayed image thereof to have the same display properties as the displayed image of the main display device according to the display properties adjustment parameters.

In summary, in the embodiments of the disclosure, the display properties information of the displayed image of the secondary display device is corrected by the main display device according to the display properties of the displayed image of the main display device, so as to adjust the displayed image of the secondary display device to have the same display properties as the displayed image of the main display device. By using the main display device to control the secondary display device to automatically adjust the display properties of the displayed image of the secondary display device in this way, consistency in the display properties between the main display device and the secondary display device can be achieved, thus considerably improving the convenience of use of the display system and the display device. In some embodiments, the update algorithm information may further be received from outside so as to update the algorithm for adjusting the display properties of the displayed image of the secondary display device, so as to ensure that the main display device adjusts the display properties of the displayed image of the secondary display device in an effective manner.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display system comprising a main display device and a plurality of secondary display devices, wherein
the plurality of secondary display devices are coupled to the main display device, the plurality of secondary display devices and the main display device respectively provide a plurality of displayed images, the plurality of secondary display devices respectively transmit display properties information corresponding to the plurality of displayed images of the plurality of secondary display devices to the main display device, the main display device corrects display properties of the plurality of displayed images of the plurality of secondary display devices according to display properties of the displayed image of the main display device, so as to adjust the plurality of displayed images of the plurality of secondary display devices to have the same display properties as the displayed image of the main display device.

2. The display system according to claim 1, wherein the main display device further comprises:
a storage circuit, storing update algorithm information received by the main display device from outside the display system, so as to update an algorithm stored in the storage circuit for adjusting the display properties of the plurality of displayed images of the plurality of secondary display devices.

3. The display system according to claim 1, wherein the display properties of the plurality of displayed images of the plurality of secondary display devices adjusted by the main display device comprise at least one of image size, brightness, chromaticity, contrast and resolution.

4. The display system according to claim 3, wherein the main display device and the plurality of secondary display devices comprise a projector, and the display properties of the plurality of displayed images of the plurality of secondary display devices adjusted by the main display device further comprise location and trapezoidal distortion of the plurality of displayed images of the plurality of secondary display devices.

5. The display system according to claim 1, wherein the plurality of secondary display devices are coupled to the main display device in a wireless manner.

6. The display system according to claim 1, wherein the main display device transmits a correction command to the plurality of secondary display devices so as to request the plurality of secondary display devices to provide the display properties information corresponding to the plurality of displayed images.

7. A display device coupled to a plurality of secondary display devices, wherein the display device and the plurality of secondary display devices respectively provide a plurality of displayed images, and the display device comprises a storage circuit and a processor,
wherein the storage circuit stores an algorithm adjusting display properties of the plurality of displayed images of the plurality of secondary display devices;
wherein the processor is coupled to the storage circuit, the processor calculates display properties adjustment parameters of the plurality of secondary display devices according to display properties of the displayed image of the display device, display properties information of the plurality of displayed images of the plurality of secondary display devices that is provided by the plurality of secondary display devices and the algorithm stored in the storage circuit, and the display device transmits the display properties adjustment parameters of the plurality of secondary display devices to the plurality of secondary display devices, so as to adjust the plurality of displayed images of the plurality of secondary display devices to have the same display properties as the displayed image of the display device.

8. The display device according to claim 7, wherein the storage circuit stores update algorithm information received by the display device from outside, so as to update the algorithm stored in the storage circuit for adjusting the display properties of the plurality of displayed images of the plurality of secondary display devices.

9. The display device according to claim 7, wherein the display properties of the plurality of displayed images of the plurality of secondary display devices adjusted by the display device comprise at least one of image size, brightness, chromaticity, contrast and resolution.

10. The display device according to claim 9, wherein the display device and the plurality of secondary display devices comprise a projector, and the display properties of the plurality of displayed images of the plurality of secondary display devices adjusted by the display device further comprise location and trapezoidal distortion of the plurality of displayed images of the plurality of secondary display devices.

11. The display device according to claim 7, wherein the display device is coupled to the plurality of secondary display devices in a wireless manner.

12. The display device according to claim 7, wherein the display device transmits a correction command to the plurality of secondary display devices so as to request the plurality of secondary display devices to provide the display properties information corresponding to the plurality of displayed images.

13. A display method of a display system, wherein the display system comprises a main display device and a plurality of secondary display devices, the display method of the display system comprising:
providing a plurality of displayed images respectively by the main display device and the plurality of secondary display devices;
receiving display properties information of the plurality of displayed images of the plurality of secondary display devices by the main display device; and
correcting the display properties information of the plurality of displayed images of the plurality of secondary display devices by the main display device according to display properties of the displayed image of the main display device, so as to adjust the plurality of displayed images of the plurality of secondary display devices to have the same display properties as the displayed image of the display device.

14. The display method of the display system according to claim 13, comprising:
updating an algorithm for adjusting the display properties of the plurality of displayed images of the plurality of secondary display devices according to update algorithm information received by the main display device from outside.

15. The display method of the display system according to claim 13, wherein the display properties of the plurality of displayed images of the plurality of secondary display devices adjusted by the main display device comprise at least one of image size, brightness, chromaticity, contrast and resolution.

16. The display method of the display system according to claim 15, wherein the main display device and the plurality of secondary display devices comprise a projector, and the display properties of the plurality of displayed images of the plurality of secondary display devices adjusted by the main display device further comprise location and trapezoidal distortion of the plurality of displayed images of the plurality of secondary display devices.

17. The display method of the display system according to claim 13, wherein the main display device is coupled to the plurality of secondary display devices in a wireless manner.

18. The display method of the display system according to claim 13, further comprising: transmitting a correction command to the plurality of secondary display devices by the main display device so as to request the plurality of secondary display devices to provide the display properties information corresponding to the plurality of displayed images.
